(19) United States
(12) Patent Application Publication
(10) Pub. No.: US 2026/0183183 A1
(43) Pub. Date: Jul. 2, 2026

(54) MASTURBATOR

(71) Applicant: KISSKY (HK) LIMITED, HONG KONG (HK)

(72) Inventor: Dewei LUO, HONG KONG (HK)

(73) Assignee: KISSKY (HK) LIMITED, HONG KONG (HK)

(21) Appl. No.: 19/006,098

(22) Filed: Dec. 30, 2024

(51) Int. Cl. A61H 19/00; A61H 23/02

(52) U.S. Cl. CPC A61H 19/44; A61H 23/0254; A61H 2201/0153; A61H 2201/0207; A61H 2201/1207; A61H 2201/14; A61H 2201/1671; A61H 2201/1676; A61H 2201/5005

(57) ABSTRACT

The present application provides a masturbator. The masturbator is provided with a shell, including a handle and a first stimulating head movably connected to the handle. The first stimulating head includes a main body and a first stimulating surface arranged on the main body. A first boss is arranged on the first stimulating surface, and one side of the first boss facing away from the first stimulating surface is provided with a third surface; and a first heating film covers the third surface. According to the masturbator, as the boss is arranged on the stimulating surface and the heating film only covers the third surface, heat is centralized in a region where a stimulating effect is most centralized, the heating efficiency is greatly improved, and the endurance of the device is improved.

### BACKGROUND

### 1. Technical Field

The present application relates to the field of sex toys, and particularly relates to a masturbator.

### 2. Background Information

With the continuous improvement of people's living standards, the demands on personal care and health products increase gradually. As a device that provides private stimulating experience, a masturbator is rapidly developed in terms of design and performance. There is a wide range of masturbators on the current market with functions from simple vibration to multi-point heating, which cannot only meet the physiological needs of users, but also improve the comfortable sensations and experience effects of the users. Therefore, realizing efficient and uniform heating within a finite volume becomes one of the key points in industrial development.

Existing masturbator products usually have overall heating solutions. A heating assembly is embedded into a device main body, so that overall heating of a stimulation head or a contact part is realized. This kind of solution often uses a design of wrapping a heating film or a heating wire with a silica gel and has the advantages of a large heating range and a relatively simple processing technology. Part of high-end products further has a multi-gear temperature adjusting function to meet the demands of different users.

Since the size of the masturbator is usually small with finite space, the battery capacity cannot be designed too large. In this case, the overall heating mode will significantly increase the power consumption of the device in the prior art, so that the using endurance is directly shortened. In addition, the overall heating mode intensifies the consumption of the electric quantity while realizing large-range heating, which easily results in energy waste. Therefore, existing overall heating solutions hardly achieve an effective balance between the heating effect and the endurance, which affects the persistent user experience of the users.

### BRIEF SUMMARY

In view of this, it is necessary to provide a masturbator capable of guaranteeing a heating effect and enhancing the endurance of a battery, to solve the above problems.

An embodiment of the present application provides a masturbator, including:
a shell, including a handle and a first stimulating head movably connected to the handle, the first stimulating head including a main body and a first stimulating surface arranged on the main body;
a swinging assembly, arranged in the handle and partially stretching outside the handle to drive the first stimulating head to swing;
a first boss, arranged on the first stimulating surface, the first boss dividing the first stimulating surface to form a first surface and a second surface, and one side of the first boss facing away from the first stimulating surface being provided with a third surface;
a first heating film, covering the third surface, a direction of the third surface pointing to the first stimulating surface being defined as a first direction,
where in the first direction, a projection area of the first stimulating surface is a, and projection areas of the first surface, the second surface, and the third surface are respectively m1, m2, and m3, respectively meeting 0.2a≤m1≤0.3a, 0.2a≤m2≤0.3a, and 0.4a≤m3≤0.6.

According to the above provided masturbator, by arranging the boss on the simulation surface, the bump of the boss is the part in contact first and with the optimal effect during stimulation; as the heating film only covers the third surface, i.e., the surface of the boss of the stimulating head in contact with a person, heat is centralized in the region where the stimulation effect is most centralized, so that the heating efficiency is greatly improved; by reducing heating in unnecessary regions, a heating mode of integrally wrapping the stimulating head is avoided; moreover, the proportional area of the third surface is set between 0.4a-0.6a, which further reduces electric energy waste brought by large-area heating while ensuring the heating effect. The endurance performance is greatly improved while the good stimulation effect is guaranteed.

### BRIEF DESCRIPTION OF THE DRAWINGS

FIG. 1 is a stereogram of a masturbator in an embodiment of the present application.

FIG. 2 is a cross-section diagram of the masturbator in FIG. 1.

FIG. 3 is a three-dimensional split view of the masturbator in FIG. 1.

FIG. 4 is a schematic diagram of proportions of a first surface, a second surface, and a third surface of the masturbator in FIG. 1.

FIG. 5 is a partially split view of the masturbator in FIG. 1.

FIG. 6 is a three-dimensional split view of the masturbator in FIG. 1.

FIG. 7 is a cross-section diagram of a masturbator in another embodiment of the present application.

FIG. 8 is a schematic diagram of proportions of a first surface, a second surface, and a third surface of the masturbator in FIG. 7.

FIG. 9 is a partially split view of the masturbator in FIG. 7.

FIG. 10 is a three-dimensional split view of the masturbator in FIG. 7.

### DESCRIPTION OF SYMBOLS OF MAIN COMPONENTS

100, masturbator; 10, shell; 11, handle; 111, limiting block; 12, first stimulating head; 121, main body; 121a, straight slot; 122, first stimulating surface; 122a, first surface; 122b, second surface; 123, fixed block; 123a, fixed groove; 124, vibrating cavity; 20, first boss; 21, third surface; 30, first heating film; 31, first heating portion; 32, second heating portion; 33, third heating portion; 40, swinging assembly; 41, motor; 42, eccentric part; 50, rotating member; 60, vibrating assembly; 61, motor; 62, eccentric block; 70, second stimulating head; 71, second stimulating surface; 72, second heating film; 80, second boss; 81, fourth surface; 90, control mechanism; 91, power supply assembly; 911, power supply; 912, fixed base; 92, control assembly; 921, control panel; 922, stepless adjusting device.

### DETAILED DESCRIPTION OF THE DRAWINGS AND THE PRESENTLY PREFERRED EMBODIMENTS

A description will be made on the technical solution in the embodiment of the present application below in combination with drawings in the embodiment of the present application. It is apparent that the described embodiments are merely a part of embodiments of the present application and are not all the embodiments.

It should be noted that when one assembly is regarded as being connected with another assembly, the assembly can be directly connected to another assembly or an assembly arranged in the center may exist as well. When one assembly is regarded as being arranged on another assembly, the assembly may be directly arranged on another assembly or an assembly arranged in the center may exist as well. The terms “top”, “bottom”, “upper”, “lower”, “left”, “right”, “front”, “back”, and similar expressions used herein are merely for description purposes.

An embodiment of the present application provides a masturbator, including:
a shell, including a handle and a first stimulating head movably connected to the handle, the first stimulating head comprising a main body and a first stimulating surface arranged on the main body;
a swinging assembly, arranged in the handle and partially stretching outside the handle to drive the first stimulating head to swing;
a first boss, arranged on the first stimulating surface, the first boss dividing the first stimulating surface to form a first surface and a second surface, and one side of the first boss facing away from the first stimulating surface being provided with a third surface;
a first heating film, covering the third surface, a direction of the third surface pointing to the first stimulating surface being defined as a first direction,
where in the first direction, a projection area of the first stimulating surface is a, and projection areas of the first surface, the second surface, and the third surface are respectively m1, m2, and m3, respectively meeting 0.2a≤m1≤0.3a, 0.2a≤m2≤0.3a, and 0.4a≤m3≤0.6.

According to the above provided masturbator, by arranging the boss on the simulation surface, the bump of the boss is the part in contact first and with the optimal effect during stimulation; as the heating film only covers the third surface, i.e., the surface of the boss of the stimulating head in contact with a person, heat is centralized in the region where the stimulation effect is most centralized, so that the heating efficiency is greatly improved; by reducing heating in unnecessary regions, a heating mode of integrally wrapping the stimulating head is avoided; moreover, the proportional area of the third surface is set between 0.4a-0.6a, which further reduces electric energy waste brought by large-area heating while ensuring the heating effect. The endurance performance is greatly improved while the good stimulation effect is guaranteed.

Embodiments of the present application will be described in detail below in combination with drawings. In the absence of conflict, the embodiments and features in the embodiments can be combined with one another.

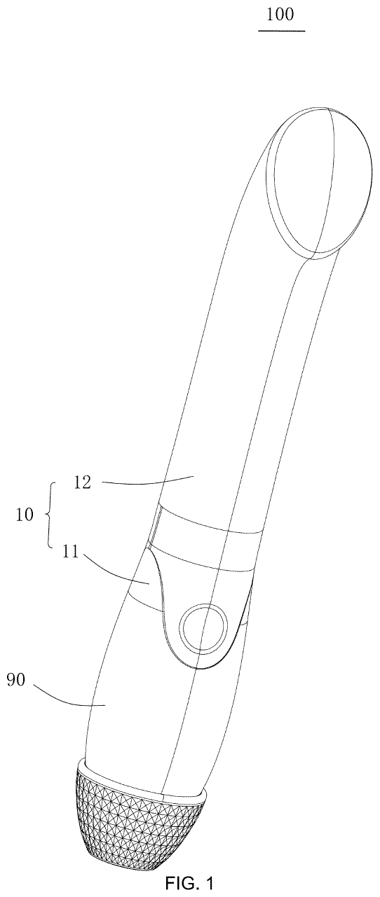

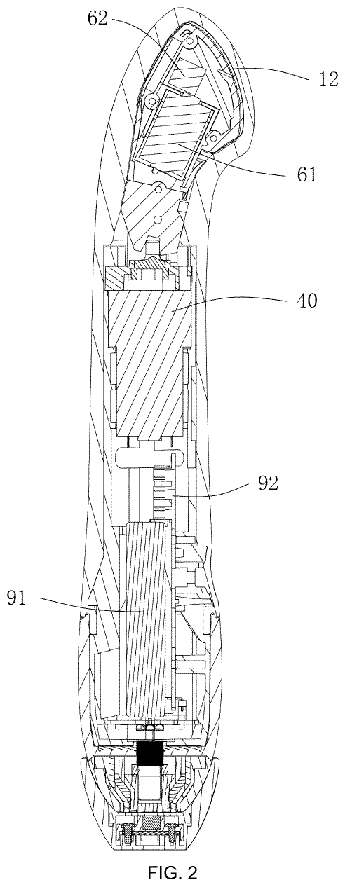

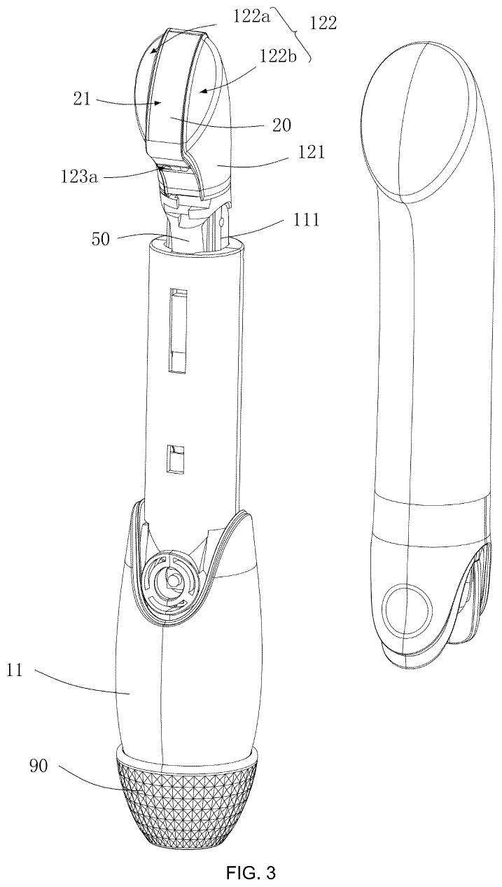

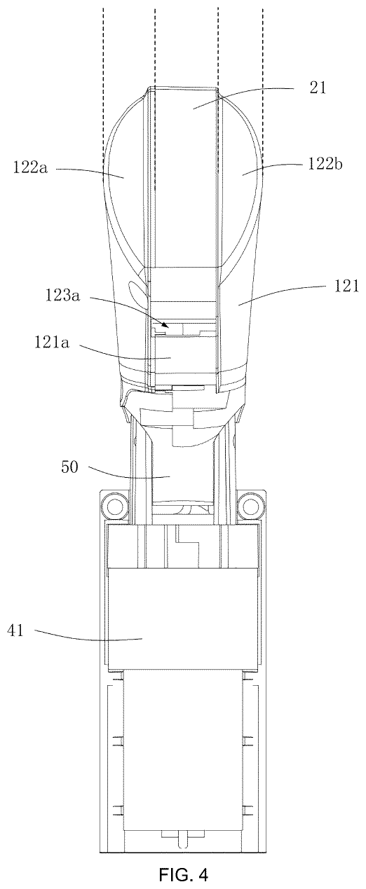

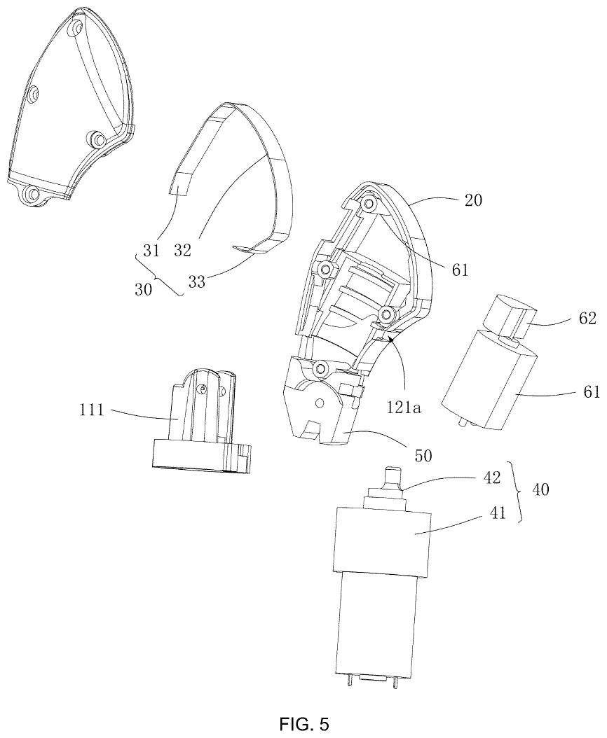

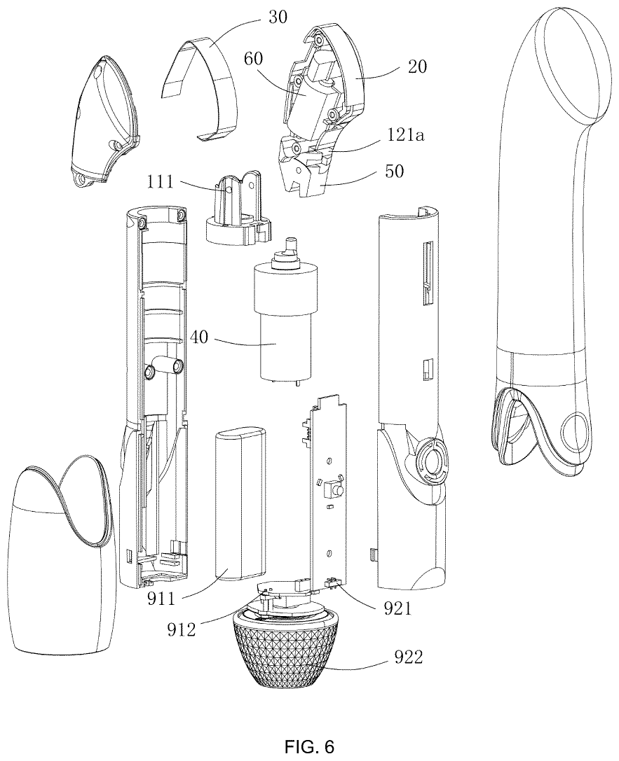

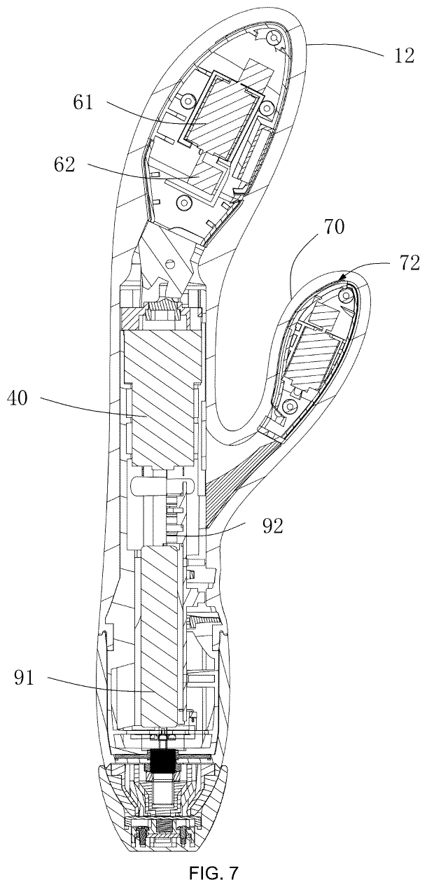

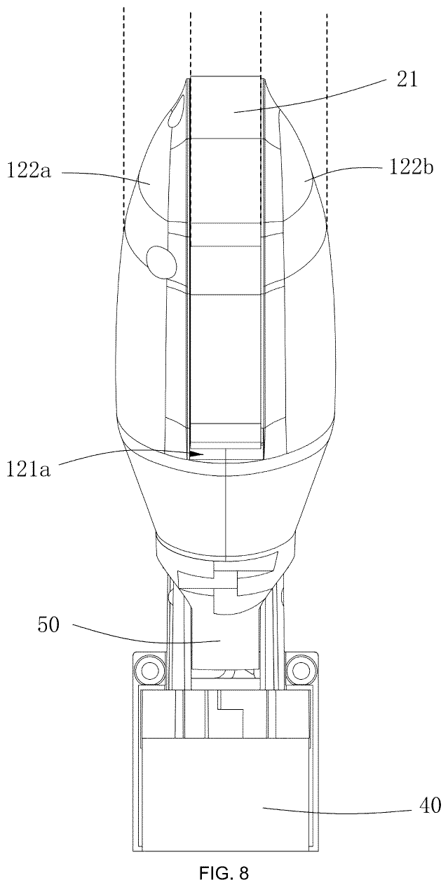

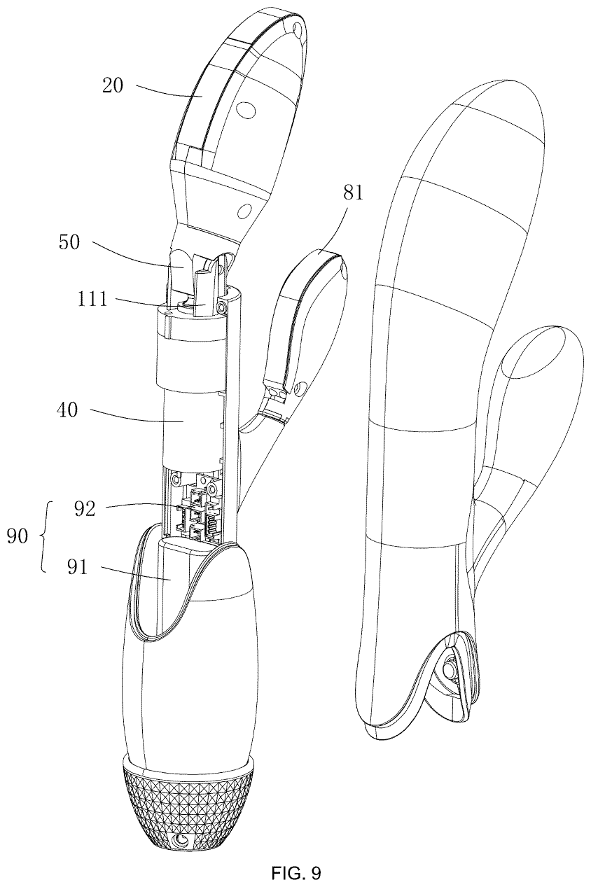

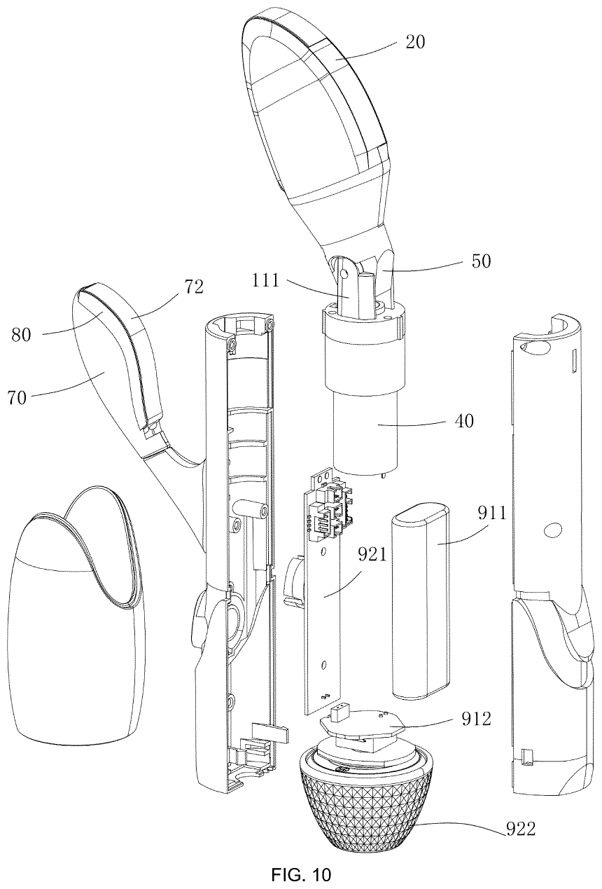

Referring to FIGS. 1-10, an embodiment of the present application provides a masturbator 100, including:
a shell 10, including a handle 11 and a first stimulating head 12 movably connected to the handle 11, the first stimulating head 12 including a main body 121 and a first stimulating surface 122 arranged on the main body 121;
a swinging assembly 40, arranged in the handle 11 and partially stretching outside the handle 11 to drive the first stimulating head 12 to swing;
a first boss 20, arranged on the first stimulating surface 122, the first boss 20 dividing the first stimulating surface 122 to form a first surface 122a and a second surface 122b, and one side of the first boss 20 facing away from the first stimulating surface 122 being provided with a third surface 21;
a first heating film 30, covering the third surface 21, a direction of the third surface 21 pointing to the first stimulating surface 122 being defined as a first direction,
wherein in the first direction, a projection area of the first stimulating surface 122 is a, and projection areas of the first surface 122a, the second surface 122b, and the third surface 21 are respectively m1, m2, and m3, respectively meeting 0.2a≤m1≤0.3a, 0.2a≤m2≤0.3a, and 0.4a≤m3≤0.6.

Specifically, the shell 10 provides an overall structure of the device. The handle 11 is held by a user to control the device. The swinging assembly 40 enables the stimulating head to swing at a certain frequency, so as to realize a uniform and continuous stimulation effect. The first stimulating head 12 is a key part to realize a specific stimulating function. The main body 121 of the stimulating head supports the overall structure, and the first stimulating surface 122 is a region in direct contact with a human body. The first boss 20 divides the stimulating surface through the shape of the bump, and the third surface 21 of the boss becomes the most significant contact region. The design of the boss centralizes the simulating action force to centralize heat and mechanical actions in a more effective contact region, so that the stimulating precision and strength are improved.

Further, the first heating film 30 directly covers the third surface 21 of the boss and provides a local heat stimulation through directional heating. The heat is centralized in the most significant contact region (the third surface 21), so that the problem of heat dispersion and too-high energy consumption as the conventional heating film covers the whole stimulating head is avoided, and the heat using efficiency and endurance are improved. The area proportion is set to avoid waste of heat and power by an excessive single stimulating area and guarantee the distributing uniformity and heat centrality, thereby improving the endurance performance of the device. The projection area of m1+m2+m3 is equal to the projection area in the same direction of the simulating surface.

The following is practical data set according to the projection area proportions:

| | m1 | m2 | m3 | | |
|---|---|---|---|---|---|
| Experimental | proportion | proportion | proportion | Heating | |
| group | (%) | (%) | (%) | effect | Endurance |
| Group 1 | 10 | 10 | 80 | Excellent | 1.3 |
| Group 2 | 15 | 15 | 70 | Comparatively | 1.5 |
| | | | | excellent | |
| Group 3 | 20 | 20 | 60 | Comparatively | 1.8 |
| | | | | excellent | |
| Group 4 | 25 | 25 | 50 | Good | 2 |
| Group 5 | 30 | 30 | 40 | Good | 2.3 |
| Group 6 | 33.3 | 33.3 | 33.3 | Medium | 2.6 |
| Group 7 | 40 | 40 | 20 | Poor | 3 |
| Group 8 | 0 | 0 | 100 | Excellent | 1 |

The above data is experimental data under equal power and equal battery capacity, and the heating effect is the somatosensory perception of the human body during use. The time of endurance is based on the state of the heating film covering the whole stimulating head in the prior art.

In conclusion, according to the experimental data, the m3 proportion is set between 40% and 60%, which can balance the heating effect and endurance. In this case, the heating effect of the simulator is still kept well, and the power consumption is effectively controlled. A balance between the endurance and the heating effect reaches the optimum level.

In a specific embodiment, m1=0.25a, m2=0.25a, and m3=0.5a.

Specifically, when the m3 proportion is 0.5a, a combination between the heating and endurance can be better balanced. The large proportion of m3 guarantees that the heat is centralized in the most effective region, which not only provides an ideal stimulation effect, but also avoids excessive heating and power waste.

In a specific embodiment, the swinging assembly 40 includes a motor 41 and an eccentric part 42 arranged on the motor 41, the motor 41 being arranged in the shell 10, one side of the eccentric part 42 facing away from the motor 41 being arranged on the stimulating head, the eccentric part 42 being configured to drive the stimulating head to swing, and the first heating film 30 being arranged in a swinging direction of the stimulating head.

Specifically, the motor 41 is a core component that drives the simulating head to swing, and converts electric energy into mechanical energy to provide necessary power to the stimulating head to swing. The motor 41 is usually arranged in the handle 11, which effectively utilizes the internal space and reduces the overall volume, and provides a stable driving force as well.

Further, the first heating film 30 is a key heating element, mounted on the stimulating head and arranged in a swinging direction thereof parallel to the movement locus of the stimulating head. This design enables the heat uniformly distributed in the contact part in the stimulating process to avoid local excess temperature or low temperature, so as to improve the using comfort and safety. Since the heating film is consistent with the swinging direction, the heat can be synchronously acted on the stimulating region with the action of the stimulating head to provide continuous and uniform heat stimulation, so as to ensure the consistency of the stimulation effect and optimize the energy consumption.

In a specific embodiment, the first heating film 30 includes a first heating portion 31, a second heating portion 32, and a third heating portion 33 arranged in sequence,
where the second heating portion 32 covers the third surface 21, the first heating portion 31 and the third heating portion 33 both are arranged on the main body 121, the main body 121 is provided with a through slot 121a, and the third heating portion 33 partially stretches into the through slot 121a to fix the first heating film 30.

Specifically, in the simulating process, the key stimulating surface is the third surface 21, the temperature of which directly affects the stimulating comfort level and effect. By heating the third surface 21, the user experience can be enhanced to the maximum extent, and the thermal therapy effect is improved. Since the third surface 21 usually covers a swinging path of the stimulating head and needs to be stably and uniformly heated to avoid discomfort or non-uniform stimulation effect caused by insufficient local temperature.

Further, the stimulating head is provided with a plurality of heating regions, including the first heating portion, the second heating portion, and the third heating portion. The first heating portion and the third heating portion are receptively located at both ends of the second heating portion. This layout can ensure that the swinging head swinging from the highest point to the lowest point can be supported with enough heat. This design enables the highest point and the lowest point be uniformly heated in the swinging process, which effectively avoids low temperature of the local region, thereby further eliminating the discomfort caused by a heat difference.

Further, in addition, the straight slot 121a is designed to provide a precise positioning function to the heating portion, which contributes to fixing the position of the heating film, thereby preventing the heating film from loosening or falling due to vibration or friction during work. Moreover, the structure of the straight slot 121a enhances the connection between the heating portion and the main body 121 of the stimulating head, which improves the overall stability and durability.

In a specific embodiment, the handle 11 further includes two limiting blocks 111 arranged parallelly, a movable groove being formed between the two limiting blocks 111 and formed in one end of the handle 11 close to the stimulating head;
the masturbator further includes a rotating member 50, the rotating member 50 being arranged between the handle 11 and the stimulating head, the rotating member 50 and the main body 121 being fixedly connected, the rotating member 50 being arranged in the movable groove, and the movable groove being configured to limit the swinging direction of the stimulating head.

Specifically, the movable groove is designed to ensure that the stimulating head supported by the handle 11 can swing within a certain angle range. The rotating member 50 matches with the limiting blocks 111 in use. The movable groove limits the swinging range of the stimulating head to prevent a difference in the heating effect due to deviation of the rotating member in the rotating process. The using process is more stable, comfortable, and controllable.

Further, the rotating member 50 is added, so that the stimulating head can swing flexibly in the limited range of the movable groove, and the rotating member 50 rotates to realize a more effective stimulating movement. The firm connection between the rotating member 50 and the main body 121 ensures that the stimulating head is kept stable in the using process and will not deviate from an established track due to swinging.

In a specific embodiment, the first stimulating head 12 further includes a plurality of fixed blocks 123, the plurality of fixed blocks 123 being arranged on an inner surface of the stimulating head to enclose a fixed groove 123a;

The masturbator further includes a vibrating assembly 60, where the vibrating assembly 60 includes a motor 61 arranged in the stimulating head and an eccentric block 62 arranged on the motor 61, the motor 61 being arranged in the fixed groove 123a, and the eccentric block 62 being arranged at one end of the motor 61 close to the first stimulating surface 122 to generate vibration.

Specifically, the fixed blocks 123 effectively ensure that the vibrating assembly 60 (including the motor 61 and the eccentric block 62) is stably positioned in the stimulating head through the enclosed fixed groove 123a. This design prevents the vibrating assembly 60 from loosening or displacing due to vibration in the working process, so as to avoid unnecessary noise or an unstable vibrating effect. The collaborative design of the fixed groove 123a and the fixed blocks 123 further enhances the mechanical stability of the vibration system in the stimulating head.

Further, according to the design of the eccentric block 62, the masturbator generates periodical vibrations due to non-uniform mass distribution during rotation. This vibration is transferred to the contact surface of the stimulating head through a structure, which can better effect with the contact region of the user, so as to provide precise and efficient vibration stimulation. The position of the eccentric block 62 is close to one end of the simulating surface, so that the vibration can be more directly transferred to the key stimulation region. Matched with the heating effect of the heating film, it provides deep physiological and psychological stimulation experience to the user.

In a specific embodiment, the fixed blocks 123 on two opposite sides of the fixed groove 123a are attached to the inner surface of the main body 121, and the fixed blocks 123 and the main body 121 enclose the vibrating cavity 124.

Specifically, the vibrating cavity 124 is a cavity structure enclosed by the fixed blocks 123 and the fixed groove 123a, which provides stable working space. This structure not only enhances the propagation effect of vibration, but also transfers the vibration to the stimulating surface uniformly, thereby improving the comfort level and effect in the using process.

Further, the vibrating cavity 124 effectively captures and accumulates heat generated by the vibrating assembly 60 in the working process through the closed design of the vibrating cavity. When the vibrating assembly 60 operates (for example, rotation of the motor 61 and the eccentric block 62), heat will be generated due to reasons such as friction. Heat in the vibrating cavity 124 is transferred to the stimulating surface through the shell 10. This heat accumulation reduces the energy waste and ensures that the heat can be effectively transferred to the surface of the stimulating head in a centralized manner, thereby further improving the warming experience during use.

Further, the vibrating cavity 124 is designed similarly to a heat recovery system that provides an extra heating efficiency for the stimulating head by using waste heat generated by the vibrating assembly 60. The vibrating assembly 60 not merely heat actively through the current-driven heating film, and the waste heat generated thereby is also effectively utilized, so that the overall heating effect is further enhanced. This design saves the energy and improves the overall heating efficiency, thereby providing more efficient and comfortable experience to the user.

In a specific embodiment, the masturbator further includes a second stimulating head 70, one end of which being arranged on the handle 11 and the other end being inclined outward; and
the masturbator further includes a second heating film 72, the second stimulating head 70 provided with a second stimulating surface 71, and the second heating film 72 covering the second stimulating surface 71 in a length direction of the second stimulating head.

Specifically, the second stimulating head 70 extends obliquely outward to better stimulate the clitoris. The second heating film 72 covers the second stimulating surface 71 in the length direction of the second stimulating head 70. The stimulating head can heat uniformly in the using process to provide a warm feeling through the heating film, so as to further improve the stimulation effect. This layout ensures that the heating effect in the stimulation region is more intensive and uniform, so that excessive local temperature or non-uniform heating is avoided, ensuring that each contact surface in the using process can obtain stable and comfortable heating experience.

In a specific embodiment, the masturbator further includes a second boss 80 arranged on the second stimulating surface 71, one side of the second boss 80 facing away from the second stimulating surface 71 being arranged on a fourth surface 81, and the second heating film 72 covering the fourth surface 81.

Specifically, by arranging the heating film on the fourth surface 81 of the second boss 80, an excessive area or non-uniform heating of the heating film is avoided, ensuring that the heat can be acted to the region needed to be heated in a centralized manner, thereby preventing energy waste. This design can maximize effective transfer of the heat by precisely controlling the heating region, so that the power consumption is reduced. The fourth surface 81 and the second boss 80 are combined structurally, so that the heating effect can be precisely and directionally acted to the stimulating part, which avoids common excessive heat dissipation in a conventional design, thereby improving the energy efficiency. The second boss 80 is similar to the first boss 20 in effect, which both aim to reduce the power consumption as much as possible while guaranteeing the heating effect, so that the overall energy efficiency and user experience are improved.

In a specific embodiment, the masturbator further includes a control mechanism 90, the control mechanism 90 including a power supply assembly 91 and a control assembly 92 in electrical connection to the power supply assembly 91; and
the power supply assembly 91 includes a power supply 911 and a fixed base 912, the fixed base 912 being arranged at the bottom of the handle 11, the power supply 911 being fixedly connected to the fixed base 912 and electrically connected to the first heating film 30 to supply power to the first heating film 30; and
the control assembly 92 includes a control panel 921 and a stepless adjusting device 922 in data connection to the control panel 921, the control panel 921 being arranged on the fixed base, and the stepless adjusting device 922 being arranged on one side of the fixed base facing away from the control panel 921 to adjust power of the first heating film 30.

Specifically, the power supply 911 provides stable power, which is a core power source for the operation of the whole system, ensuring that the device can work effectively. The fixed base 912 is located at the bottom of the handle 11 to physically support the power supply 911 and ensure that the power supply is stably connected to other assemblies, ensuring the stability and safety of the power supply 911 in the using process. The design of the fixed base ensures stable connection between the power supply 911 and the heating film, so that the heating performance is improved and the duration of use is prolonged. The fixed base 912 further effectively protects the power supply 911 and a circuit to prevent a poor connection caused by vibration or swinging.

Further, the control panel 921 is an interface through which the user interacts with the device and usually includes a button, a display screen, or a touch screen and the like for displaying information such as temperature and power setting. The user can adjust the working mode of the device through the control panel 921. The stepless adjusting device 922 is located on the other side of the fixed base and is mainly configured to precisely adjust the power of the heating film, so as to change the heating effect. The stepless adjusting design enables the user to seamlessly adjust the heating temperature or intensity according to a personal demand, so as to provide more personalized user experience.

The stepless adjusting device 922 enables the user to precisely adjust the heating intensity, which prevents a limitation of a preset gear of the conventional masturbator, providing more flexibility and comfort. The stepless adjusting device 922 also can adjust the vibrating frequency of the simulating head and is switched through the control panel 921 to adjust a plurality of functions.

Further, control of the control assembly 92 is inputted by long-pressing a program detection button. When detecting that a switch is long-pressed to be valid, it enters a working mode, and the motor 61 output is controlled through the PWM; in the corresponding working mode, the program controls a heating device to realize a constant temperature output through NTC temperature detection; the program detection button is short-pressed to input; when detecting that the switch is short-press to be valid, it is cyclically switched to work, and the rotating speed and rotating mode of the motor 61 in the corresponding mode are switched; the program detection button is long-pressed to input to enter a shutdown mode from the working mode, and the program stores the corresponding working mode; and in each working mode, the motor 61 can be subjected to stepless variable speed through the encoder.

Stepless variable speed outputs a PWM (PWM is a technology for modulating the width of a series of pulses, which equivalently obtains required waveforms by changing the width of the pulses) signal to control the motor 61 through a program; the program detects an input of an encoder to judge the rotating direction of the encoder, and the program specifically changes the duty cycle (the signal consists of a high level and a low level, and the motor 61 output is controlled by adjusting the time proportion of the high level) according to the rotating direction to control a variable-speed output; and by detecting the input of the encoder, the program realizes the stepless variable-speed control of the motor 61 by adjusting the output of the duty cycle.

The above is merely the implementation of the present disclosure. It should be noted that those of ordinary skill in the art may further make improvements without departing from the creative concept of the present application, and these improvements all fall within the protection scope of the present application.

1. A masturbator, comprising:
a shell, comprising a handle and a first stimulating head movably connected to the handle, the first stimulating head comprising a main body and a first stimulating surface arranged on the main body;
a second stimulating head, one end of which being arranged on the handle and the other end being inclined outward, the second stimulating head being provided with a second stimulating surface;
a first boss, arranged on the first stimulating surface, the first boss dividing the first stimulating surface to form a first surface and a second surface, and one side of the first boss facing away from the first stimulating surface being provided with a third surface;
a first heating film, covering the third surface, a direction of the third surface pointing to the first stimulating surface being defined as a first direction; and
a second heating film, covering the second stimulating surface in a length direction of the second stimulating head,
wherein in the first direction, a projection area of the first stimulating surface is a, and projection areas of the first surface, the second surface, and the third surface are respectively m1, m2, and m3, respectively meeting 0.2a≤m1≤0.3a, 0.2a≤m2≤0.3a, and 0.4a≤m3≤0.6.

2. The masturbator according to claim 1, wherein m1=0.25a, m2=0.25a, and m3=0.5a.

3. The masturbator according to claim 1, further comprising a swinging assembly, wherein
the swinging assembly comprises a motor and an eccentric part arranged on the motor, the motor being arranged in the shell, one side of the eccentric part facing away from the motor being arranged on the stimulating head, the eccentric part being configured to drive the stimulating head to swing, and the first heating film being arranged in a swinging direction of the stimulating head.

4. The masturbator according to claim 3, wherein the first heating film comprises a first heating portion, a second heating portion, and a third heating portion arranged in sequence;
the second heating portion covers the third surface, the first heating portion and the third heating portion both are arranged on the main body, the main body is provided with a through slot, and the third heating portion partially stretches into the through slot to fix the first heating film.

5. The masturbator according to claim 3, wherein the handle further comprises two limiting blocks arranged parallelly, a movable groove being formed between the two limiting blocks and formed in one end of the handle close to the stimulating head;
the masturbator further comprises a rotating member, the rotating member being arranged between the handle and the stimulating head, the rotating member and the main body being fixedly connected, the rotating member being arranged in the movable groove, and the movable groove being configured to limit the swinging direction of the stimulating head.

6. The masturbator according to claim 1, wherein the first stimulating head further comprises a plurality of fixed blocks, the plurality of fixed blocks being arranged on an inner surface of the stimulating head to enclose a fixed groove;
the masturbator further comprises a vibrating assembly, wherein the vibrating assembly comprises a motor arranged in the stimulating head and an eccentric block arranged on the motor, the motor being arranged in the fixed groove, and the eccentric block being arranged at one end of the motor close to the first stimulating surface to generate vibration.

7. The masturbator according to claim 6, wherein the fixed blocks on two opposite sides of the fixed groove are attached to the inner surface of the main body, and the fixed blocks and the main body enclose the vibrating cavity.

8. The masturbator according to claim 1, further comprising a second boss arranged on the second stimulating surface, one side of the second boss facing away from the second stimulating surface being arranged on a fourth surface, and the second heating film covering the fourth surface.

9. The masturbator according to claim 1, further comprising a control mechanism, wherein the control mechanism comprises a power supply assembly and a control assembly electrically connected to the power supply assembly, the power supply assembly and the control assembly both being arranged on one side of the handle away from the first stimulating head, and the power supply assembly being configured to supply power to the first heating film and the second heating film.

10. The masturbator according to claim 9, wherein the power supply assembly comprises a power supply and a fixed base, the fixed base being arranged at a bottom of the handle, and the power supply being fixedly connected to the fixed base; and
the control assembly comprises a control panel and a stepless adjusting device in data connection to the control panel, the control panel being arranged on the fixed base, and the stepless adjusting device being arranged on one side of the fixed base facing away from the control panel to adjust power of the first heating film.
